(19) United States
(12) Patent Application Publication
(10) Pub. No.: US 2011/0234410 A1
(43) Pub. Date: Sep. 29, 2011

(54) Solar Powered Animal Containment/Repellent System

(76) Inventors: William S. Groh, Shekou (CN); Duane A. Gerig, Knoxville, TN (US); David M. Kozak, Bean Station, TN (US)

(21) Appl. No.: 12/731,279

(22) Filed: Mar. 25, 2010

(51) Int. Cl. G08B 23/00; A01K 15/04

(52) U.S. Cl. 340/573.3; 119/720

(57) ABSTRACT

Described is an animal containment/repellant system for containing and animal within or repelling an animal from a designated area and for optimizing an integral power source of the system. More specifically, the animal containment/repellant system supplements the operating power provided by its internal power source with power derived from solar energy and charges its power source using the derived power. Additionally, the animal containment/repellant system employs a power conservation scheme to minimize the use of its internal power source.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention pertains to a solar powered system for containing an animal within or repelling an animal from a designated area.

2. Description of the Related Art

It is common for a pet owner to have a need to contain a pet within or restrict a pet from a particular area without having to use a physical aesthetically unpleasing barrier. For example, a pet owner may have an ornamental flower garden, from which he wishes to restrict the pet. Because the garden is ornamental, that is for aesthetic appeal, a physical structure, such as a fence, is not a viable solution to restricting the pet from the garden. To address this type of situation, conventional pet repellant systems have provided an intangible means for restricting a pet from an outdoor restricted area. More specifically, conventional pet repellant systems typically include a transmitter unit and a receiver unit. The transmitter unit generates and transmits a signal, and the receiver unit, which is carried by the pet, delivers a stimulus to the pet when it receives the transmitted signal. The transmitter unit is positioned within the restricted area, typically at the center thereof, such that the signal radiates from the transmitter unit to at least the perimeter of the area, thus having a presence within the restricted area. Consequently, when the pet approaches the restricted area, the receiver unit detects the signal and delivers a stimulus to the pet, discouraging the pet from approaching the restricted area.

Conventional pet repellant systems are limited in that providing the transmitter unit with sufficient operating power is problematic. More specifically, it is not reasonable for the transmitter unit to have a power cord in electrical communication with a conventional AC outlet because running a cord from the restricted area to the outlet is unsightly and would detract from any aesthetic appeal associated with the restricted area. Additionally, because the restricted area is typically within the pet owner's lawn, the cord would necessarily run from the restricted area, across the lawn, and to a structure having the AC outlet. As a result, the cord poses a hazard to anyone walking in the lawn and must be tended to every time the lawn is mowed. Another limited solution provided by conventional systems is to provide the transmitter unit with batteries for supplying operating power. However, because the transmitter unit is continuously transmitting the signal, the batteries become discharged within a short period of time. This limitation is significant because, unless the pet owner is extremely diligent in exchanging the batteries, the conventional pet repellant systems have frequent periods of unintended inoperability. Additionally, continuously exchanging the batteries presents an inconvenience for the pet owner. More specifically, because the transmitter unit is positioned at the center of the restricted area, the pet owner must enter the restricted area to retrieve and to reposition the transmitter unit each time the batteries are replaced. Additionally, repeatedly disturbing the restricted area potentially detracts from any aesthetic appeal associated with the area. Consequently, a system that repels a pet from a restricted area and that maximizes an internal power source is desired.

### BRIEF SUMMARY OF THE INVENTION

In accordance with the various features of the present invention there is provided an animal containment/repellant system for containing an animal within or repelling an animal from a designated area and for optimizing an internal power source of the system. More specifically, the animal containment/repellant system includes a base unit and a rover unit. The base unit includes a photovoltaic (PV) array, power regulation electronics, a rechargeable power source, base unit electronics, and an antenna. The PV array converts solar energy to electrical energy, and the power regulation electronics use the electrical energy to charge the power source and to provide the base unit electronics with operating power, the power source also providing the base unit electronics with operating power. The base unit electronics generate an activation signal and radiate the activation signal from the base unit by way of the antenna. The radiated activation signal defines the designated area. The rover unit is carried by the animal and includes a receiver and a stimulus delivery device. The receiver is adapted to receive the activation signal, and when the signal strength of the activation signal at the receiver reaches a predetermined threshold, the stimulus delivery device delivers a stimulus to the animal. As a result, when the base unit is disposed at the center of an area within which the animal is to be contained, the rover unit delivers a stimulus to the animal when the animal moves a predetermined distance from the base unit. More specifically, as the animal moves further from the base unit, the signal strength of the activation signal at the receiver decreases until it reaches the threshold, at which time the rover unit delivers a stimulus to the animal, discouraging the animal from continuing to move away from the base unit and thus moving beyond the designated area. Additionally, when the base unit is disposed at an area desired to be inaccessible by the animal, the rover unit delivers a stimulus to the animal when the animal approaches the area. More specifically, as the animal approaches the base unit, the signal strength of the activation signal at the receiver increases until it reaches the threshold, at which time the rover unit delivers a stimulus to the animal, discouraging the animal from continuing to approach the base unit and thus the designated area.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram of one embodiment the animal containment/repellant system;

FIG. 2 is a block diagram of one embodiment of the power regulation electronics of the animal containment/repellant system of FIG. 1;

FIG. 3 is an exploded view of one embodiment of the base unit of the animal containment/repellant system;

FIG. 4 illustrates one embodiment of the animal containment/repellant system of FIG. 1; and

FIG. 5 illustrates an alternate embodiment of the animal containment/repellant system, whereby the antenna is a wire.

### DETAILED DESCRIPTION OF THE INVENTION

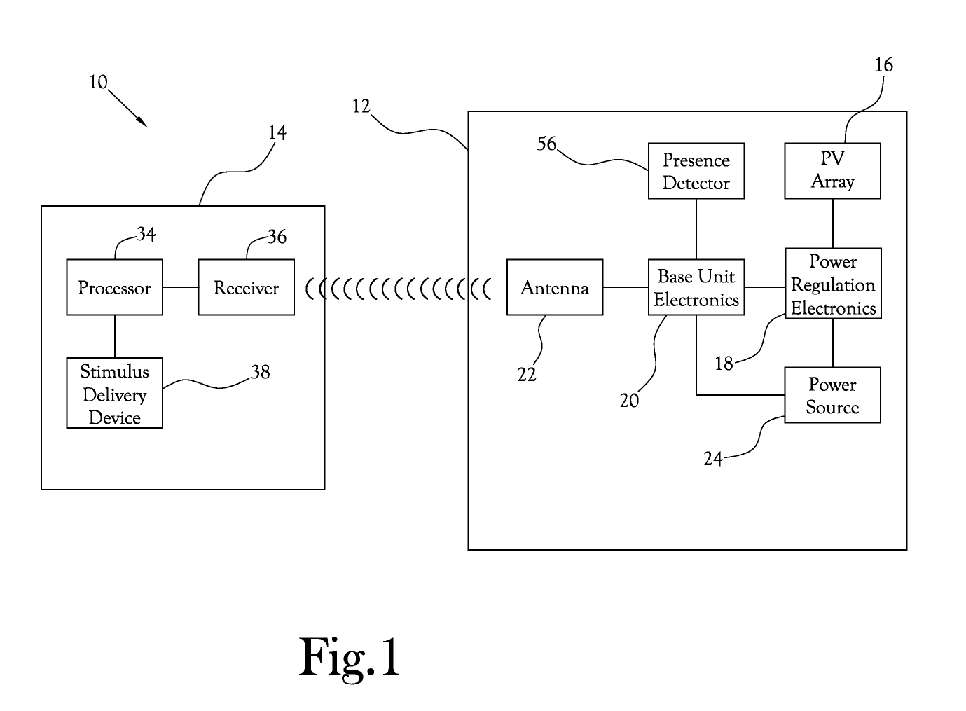

The present invention provides an animal containment/repellant system for containing an animal within or repelling an animal from a designated area and for optimizing an internal power source of the system. More specifically, the animal containment/repellant system supplements the operating power provided by its internal power source with power derived from solar energy and charges its power source using the derived power. Additionally, the system employs a power conservation scheme to minimize the use of its internal power source. A block diagram of one embodiment of the animal containment/repellant system constructed in accordance with the various features of the present invention is illustrated generally at 10 in FIG. 1.

The animal containment/repellant system 10 includes a base unit 12 and a rover unit 14. Generally, the base unit 12 generates and radiates an activation signal. The rover unit 14 is adapted to be carried by an animal and is responsive to the activation signal such that when the signal strength of the activation signal at the rover unit 14 reaches a predetermined threshold, the rover unit 14 delivers a stimulus to the animal. As a result, the locations at which the activation signal has a signal strength equal to the predetermined threshold define the perimeter of a designated area, which can be a containment area or a restricted area. Accordingly, when the designated area is a containment area and the animal carries the rover unit 14 outside the containment area, the rover unit 14 delivers a stimulus to the animal, discouraging the animal from moving beyond the containment area. Similarly, when the designated area is a restricted area and the animal carries the rover unit 14 within the restricted area, the rover unit 14 delivers a stimulus to the animal, discouraging the animal from entering the restricted area.

The base unit 12 includes a PV array 16, power regulation electronics 18, base unit electronics 20, an antenna 22, and a power source 24. The PV array 16 is in electrical communication with the power regulation electronics 18, which is in electrical communication with the base unit electronics 20 and the power source 24, the power source 24 also being in electrical communication with the base unit electronics 20, which is in electrical communication with the antenna 22. The base unit electronics 20 generate the activation signal and radiate the activation signal by way of the antenna 22 in accordance with the above discussion. The PV array 16 is an array of photovoltaic cells, or solar cells, that is adapted to convert solar energy into electrical energy. In one embodiment, the PV array 16 is manufactured using an epoxy encapsulation process that provides the array 16 with UV inhibitors, maximizing the convertible solar energy at the array 16. The converted electrical energy is received by the power regulation electronics 18, which output the electrical energy as regulated electrical power to both the base unit electronics 20 and the power source 24. More specifically, the power regulation electronics 18 regulate the received electrical energy such that the respective power output to the base unit electronics 20 and the power source 24 is not greater than the respective component is designed to manage.

The power source 24 is rechargeable and adapted to provide operating power to the base unit electronics 20. The power source 24 receives its charge from the electrical energy converted by the PV array 16 by way of the power regulation electronics 18. In one embodiment, the power source 24 includes a plurality of rechargeable 1.2V AA Nickel Cadmium (NiCd) batteries. In one embodiment, when the power source 24 is fully charged and the PV array 16 is converting energy, the energy is channeled to the base unit electronics 20, in accordance with the above discussion, such that the PV array 16 provides the base unit electronics 20 with at least a portion of its operating power, supplementing the operating power provided by the power source 24 and preserving the power in the power source 24. In another embodiment, the power regulation electronics 18 trickle charge the power source 24 while providing operating power to the base unit electronics 20.

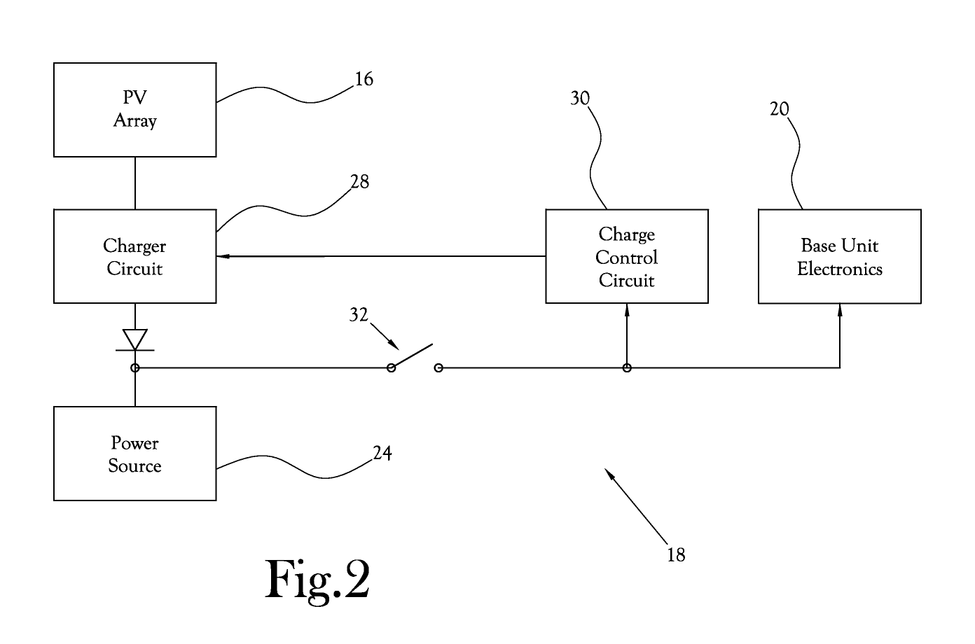

A block diagram of one embodiment of the power regulation electronics 18 in electrical communication with the PV array 16 and the power source 24 is illustrated at FIG. 2. In the illustrated embodiment, the power regulation electronics 18 include a charger circuit 28 and a charge control circuit 30, and the base unit 12 includes a user operable power switch 32. The charger circuit 28 receives electrical energy from the PV array 16, dictates whether the power source 24 is trickle charged or fast charged, and provides charging power to the power source 24 accordingly. In one embodiment, the charger circuit 28 is in electrical communication with a user interface such that the user determines whether the power source 24 is trickle charged or fast charged. When the power switch 32 is positioned at the closed position, the power source 24 and the charger circuit 28 are in electrical communication with the base unit electronics 20. In the illustrated embodiment, the charge control circuit 30 monitors the power received by the base unit electronics 20 and, by way of communication with the charger circuit 28, limits the power in accordance with the above discussion.

Considering again FIG. 1, the rover unit 14 includes a processor 34, a receiver 36, and a stimulus delivery device 38, the processor 34 being in electrical communication with the receiver 36 and the stimulus delivery device 38. The receiver 36 is adapted to receive the activation signal radiated by the base unit 12. In accordance with the above discussion, when the signal strength of the activation signal at the receiver 36 reaches the predetermined threshold, the processor 34 activates the stimulus delivery device 38 such that the stimulus delivery device 38 delivers a stimulus to the animal. The strength at which the base unit electronics 20 transmit the activation signal is adjustable such that the size of the designated area is adjustable.

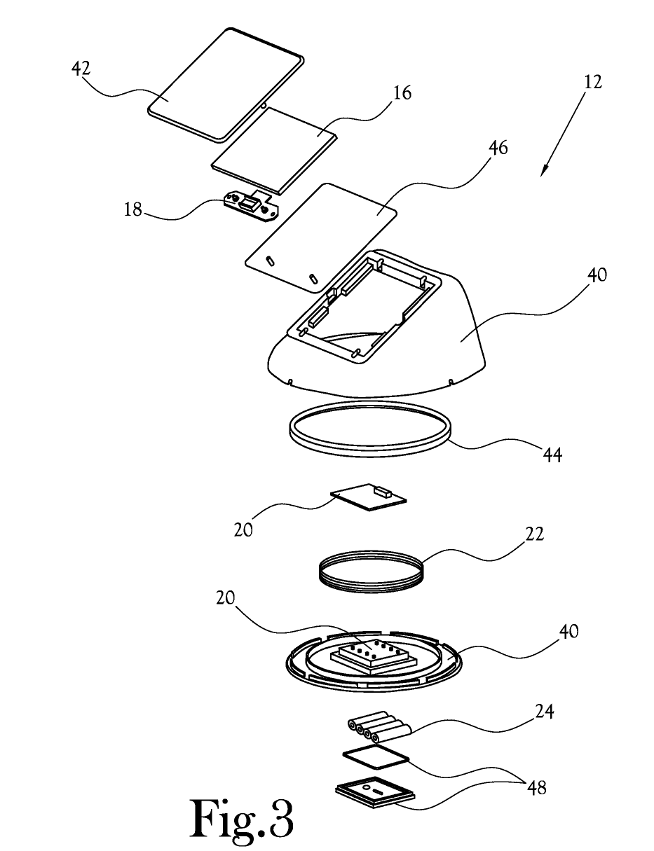

FIG. 3 illustrates one embodiment of the base unit 12 in accordance with the various features of the present invention. The base unit 12 includes a housing 40 and a PV array window 42. The PV array 16, the power regulation electronics 18, the base unit electronics 20, and the power source 24 are disposed within the housing 40. Because the animal containment/repellant system 10 is typically employed outdoors, in one embodiment, the housing 40, the PV array window 42, and the cooperation thereof generate a waterproof housing for the components disposed within the housing 40. Further, in the illustrated embodiment, the base unit 12 includes a gasket 44 for waterproofing the connection point of two portions of the housing 40. Additionally, in one embodiment, the housing 40 is UV resistant such that it is not damaged by extended exposure to the sun. The PV array window 42 provides structural protection for components disposed within the housing 40, but permits free passage of solar energy through the window 42. For example, in one embodiment, the PV array window 42 is a polycarbonate window. As a result, the PV array 16 is disposed within the housing 40 such that it receives the solar energy that passes through the PV array window 42. In the illustrated embodiment, the base unit 12 includes a PV array support member 46 that positions the PV array 16 with respect to the PV array window 42 so as to maximize the amount of solar energy received by the PV array 16. Additionally, in the illustrated embodiment, the base unit 10 includes a power source support assembly 48 that structurally positions the power source 24 such that it is in electrical communication with the base unit electronics 40 and the power regulation electronics 18.

In the illustrated embodiment, the antenna 22 is a coil disposed within the housing 40. As a result, the activation signal is effectively radiated from the housing 40 of the base unit 12. In an alternate embodiment, the antenna 22 is a single wire loop that extends from the housing 40 and defines an enclosure, the wire being positioned at the desired perimeter of the designated area. The activation signal is radiated from the wire such that the perimeter of the designated area is defined at the wire.

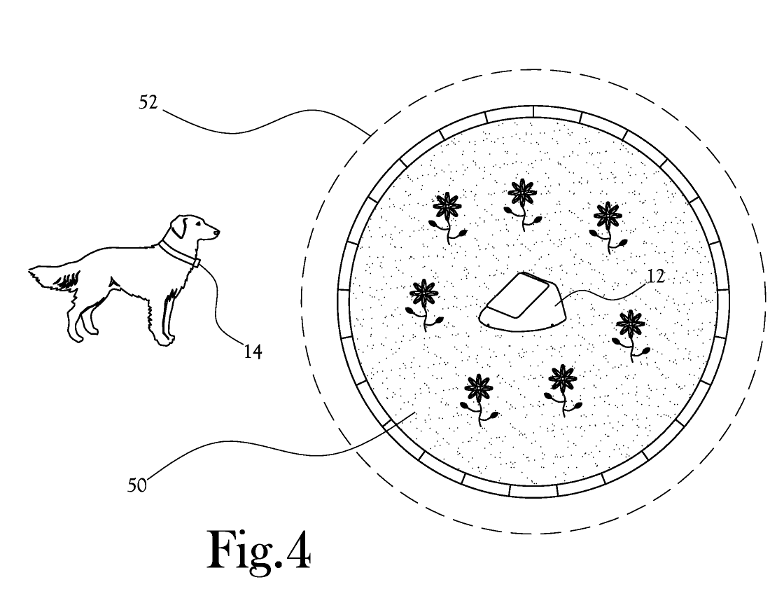

FIG. 4 illustrates one embodiment of the animal containment/repellant system 10 in accordance with the various features of the present invention. In the illustrated embodiment, the base unit 12 is disposed within a flower garden 50 and the designated area is a restricted area. Additionally, the base unit 12 is adjusted to radiate the activation signal such that the perimeter of the restricted area 52 is defined about the perimeter of the flower garden 50. Stated differently, the flower garden 50 is within the restricted area. As a result, when the animal approaches the flower garden 50 within close proximity thereto, the rover unit 14 delivers a stimulus to the animal, discouraging the animal from entering the flower garden 50.

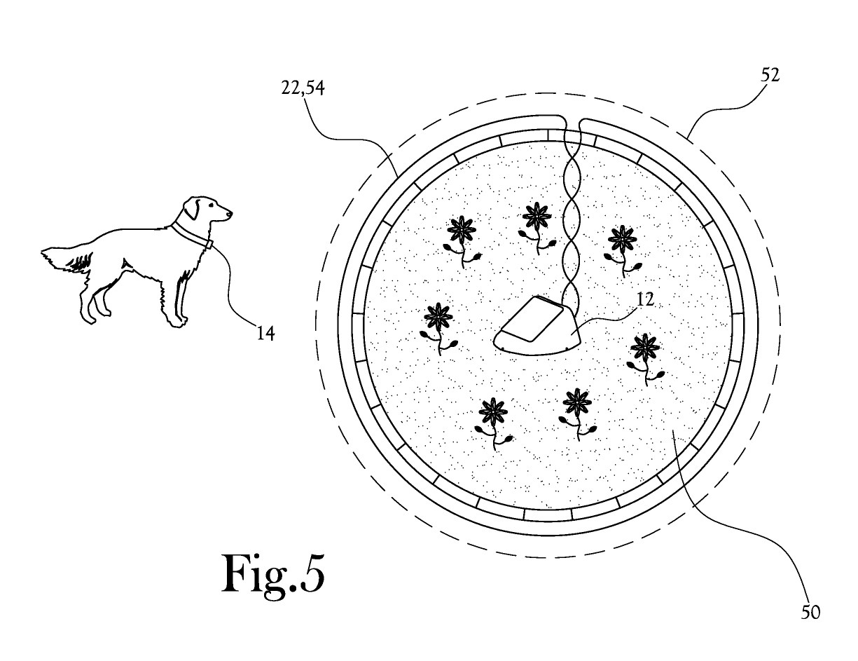

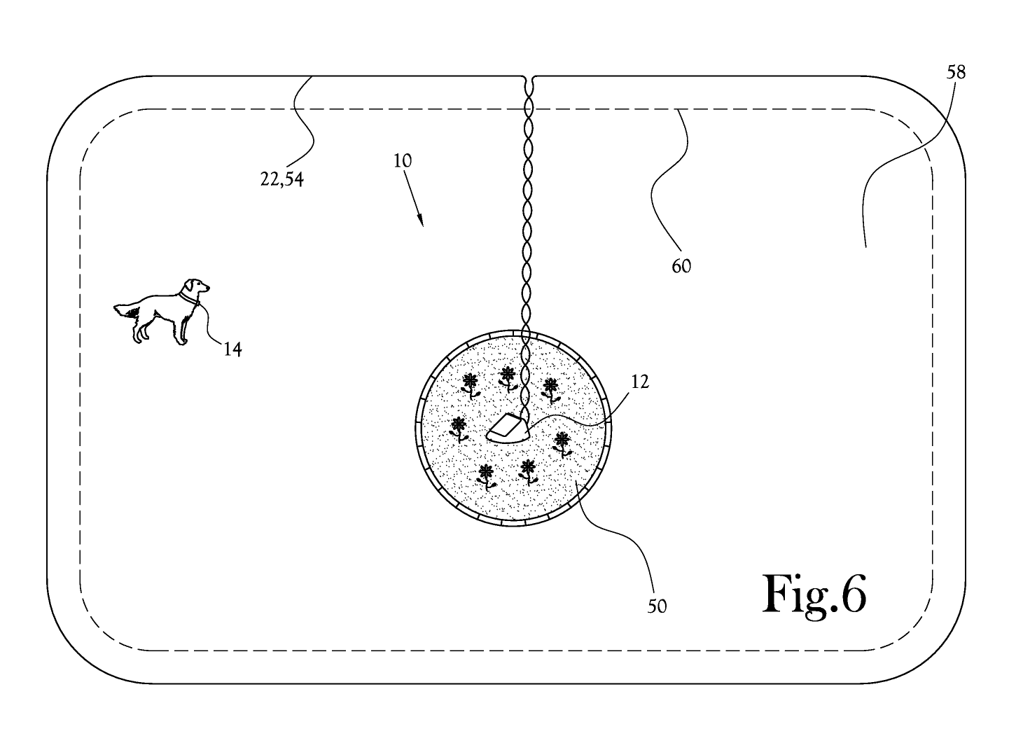

FIG. 5 illustrates one embodiment of the animal containment/repellant system 10 wherein the antenna 22 is a single wire loop 54. In the illustrated embodiment, the base unit 12 is disposed within the flower garden 50, the wire 54 is positioned about the perimeter of the flower garden 50, and the designated area is a restricted area. The base unit 12 radiates the activation signal such that the perimeter of the restricted area 52 is defined about the flower garden 50 to the extent that the flower garden 50 is within the restricted area. As a result, when the animal approaches the flower garden 50 within close proximity thereto, the rover unit 14 delivers a stimulus to the animal, discouraging the animal from entering the flower garden 50.

In the illustrated embodiment of FIG. 1, the animal containment/repellant system 10 includes a presence detector 56 in electrical communication with the base unit electronics 20. In this embodiment, the presence detector 56 is adapted to detect the presence of the animal when the animal is proximate the perimeter of a restricted area 52. When the presence detector 56 detects the presence of the animal, it generates a presence signal and does not generate the presence signal otherwise. When the base unit electronics 20 do not receive the presence signal, the base unit electronics 20, the antenna 22, and various other electrical components of the base unit 12 are substantially deactivated such that they consume nominal amounts of power. On the other hand, when the base unit electronics 20 receive the presence signal, the base unit electronics 20 activate the components of the base unit 12 such that the base unit 12 operates as discussed above. As a result, the base unit 12 employs a power conservation scheme in that it is fully activated only when the animal is proximate the restricted area 52 such that it does not consume significant amounts of power when the animal is not near the restricted area 52.

FIG. 6 illustrates another embodiment of the animal containment/repellant system 10 wherein the antenna 22 is a single wire loop 54. In the illustrated embodiment, the base unit 12 is disposed within the flower garden 50, the wire 54 is positioned about the perimeter of a yard 58, and the designated area is a containment area. The base unit 12 radiates the activation signal such that the perimeter of the containment area 60 is defined at the perimeter of the yard 58 to the extent that the yard 58 defines the containment area. As a result, when the animal approaches the perimeter of the yard 58 within close proximity thereto, the rover unit 14 delivers a stimulus to the animal, discouraging the animal from moving beyond the yard 58.

In one embodiment, the housing 40 of the base unit 12 is designed for aesthetic appeal. For example, the base unit 12 can have a housing 40 that resembles a stone, yard gnome, a decorative mushroom, a pathway stone, or any other ornament that coordinates with the decor of the surrounding landscape.

From the foregoing description, those skilled in the art will recognize that an animal containment/repellant system for containing and animal within or repelling an animal from a designated area offering advantages over the prior art has been provided. More specifically, the animal containment/repellant system supplements the operating power provided by its internal power source with power derived from solar energy and charges its power source using the derived power. Additionally, the system employs a power conservation scheme to minimize the use of its internal power source.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. An animal containment/repellant system comprising:
a base unit comprising:
base unit electronics that generate an activation signal;
a rechargeable power source in electrical communication with said base unit electronics, said power source provides said base unit electronics with operating power;
a photovoltaic (PV) array in electrical communication with said power source, said PV array converts solar energy into electrical energy, said power source is recharged by electrical energy converted by said PV array; and
an antenna in electrical communication with said base unit electronics, said base unit electronics drive the activation signal into said antenna such that the activation signal radiates from said antenna, the activation signal defines a designated area; and
a rover unit adapted to be carried by an animal, said rover unit comprising:
a receiver responsive to the activation signal; and
a stimulus delivery device in electrical communication with said receiver, said stimulus delivery device being adapted to deliver a stimulus to the animal when the signal strength of the activation signal at said receiver reaches a predetermined threshold.

2. The animal containment/repellant system of claim 1 wherein said PV array is in electrical communication with said base unit electronics, electrical energy converted by said PV array provides said base unit electronics with operating power, supplementing the operating power provided by said power source.

3. The animal containment/repellant system of claim 1 wherein said base unit further comprises power regulation electronics in electrical communication with said PV array, said base unit electronics, and said power source, said power regulation electronics regulate the amount of electrical energy converted by said PV array that is received by said base unit electronics and said power source.

4. The animal containment/repellant system of claim 3 wherein said power regulation electronics route electrical energy converted by said PV array to said base unit electronics.

5. The animal containment/repellant system of claim 1 wherein said base unit further comprises a presence detector in electrical communication with said base unit electronics, said presence detector detects the presence of the animal when the animal is proximate to the perimeter of the designated area, said presence detector generates a presence signal when it detects the presence of the animal, said base unit electronics deactivate various electrical components of said base unit when said presence detector does not generate the presence signal, said base unit electronics activate electrical components of said base unit when said presence detector generates the presence signal.

6. The animal containment/repellant system of claim 5 wherein the electrical components of said base unit consume nominal amounts of power when deactivated.

7. The animal containment/repellant system of claim 1 wherein said antenna is a coil disposed within said base unit.

8. The animal containment/repellant system of claim 1 wherein said antenna is a wire loop adapted to be disposed at the perimeter of the designated area.

9. The animal containment/repellant system of claim 1 wherein the designated area is a restricted area such that said animal containment/repellant system repels the animal from the restricted area.

10. The animal containment/repellant system of claim 1 wherein the designated area is a containment area such that said animal containment/repellant system contains the animal within the containment area.

11. The animal containment/repellant system of claim 1 wherein said stimulus delivery device is adapted to deliver a warning stimulus and a correction stimulus.

12. The animal containment/repellant system of claim 1 wherein said base unit further comprises a housing.

13. The animal containment/repellant system of claim 12 wherein said housing is weatherproof.

14. The animal containment/repellant system of claim 12 wherein said housing is designed to have aesthetic appeal.

15. The animal containment/repellant system of claim 14 wherein said housing has the appearance of a gnome, a yard ornament, or a stone.

16. An animal containment/repellant system comprising:
a base unit comprising:
a housing having a PV array window, the PV array window permitting substantially unrestricted passage of solar energy;
a photovoltaic (PV) array disposed within said housing and proximate the PV array window, said PV array converts solar energy to electrical energy;
power regulation electronics disposed within said housing, said power regulation electronics being in electrical communication with said PV array;
a power source disposed within said housing, said power source being in electrical communication with said power regulation electronics, said power source being rechargeable, said power regulation electronics recharge said power source using electrical energy converted by said PV array;
base unit electronics disposed within said housing, said base unit electronics being in electrical communication with said power source and said power regulation electronics, said power source provides said base unit electronics with operating power, said power regulation electronics provide said base unit electronics with operating power, the operating power provided by said power regulation electronics being electrical energy converted by said PV array, said base unit electronics generate an activation signal; and
an antenna in electrical communication with said base unit electronics, said base unit electronics radiating the activation signal from said base unit by way of said antenna, the radiated activation signal defines a designated area; and
a rover unit adapted to be carried by the animal, said rover unit comprising:
a receiver adapted to receive the activation signal;
a processor in electrical communication with said receiver, said processor verifies reception of the activation signal and determines the signal strength thereof; and
a stimulus delivery device in electrical communication with said processor, said processor activates said stimulus delivery device when said processor determines that the signal strength of the activation signal satisfies a predetermined threshold, said stimulus delivery device delivers a stimulus to the animal when activated.

17. The animal containment/repellant system of claim 16 wherein said base unit further comprises a presence detector in electrical communication with said base unit electronics, said presence detector detects the presence of the animal and generates a presence signal when the presence of the animal is detected, said base unit electronics deactivate at least one electrical component of said base unit when said presence detector does not generate the presence signal, said base unit electronics activate the electrical components of said base unit when said presence detector generates the presence signal.

18. The animal containment/repellant system of claim 17 wherein the electrical components of said base unit consume nominal amounts of power when deactivated.

19. The animal containment/repellant system of claim 16 wherein the designated area is a restricted area such that said animal containment/repellant system repels the animal from the restricted area.

20. The animal containment/repellant system of claim 16 wherein the designated area is a containment area such that said animal containment/repellant system contains the animal within the containment area.

21. The animal containment/repellant system of claim 16 wherein said antenna is a coil disposed within said housing.

22. The animal containment/repellant system of claim 16 wherein said antenna is a wire loop adapted to be disposed at the perimeter of the designated area.
